(19) United States
(12) Patent Application Publication
(10) Pub. No.: US 2004/0138929 A1
(43) Pub. Date: Jul. 15, 2004

(54) Restaurant table management system

(76) Inventors: Steven T. Awiszus, St. Paul, MN (US); Abolghassem B. Mahmoodi, St. Paul, MN (US); Smarajit Mitra, St. Paul, MN (US); James C. Medek, Shoreview, MN (US); Matthew D. Moore, Lake Elmo, MN (US); Nicholas A. Stark, Cottage Grove, MN (US); Nicholas P. Johns, Minneapolis, MN (US)

Correspondence Address: 3M INNOVATIVE PROPERTIES COMPANY, PO BOX 33427, ST. PAUL, MN, 55133-3427, US

(21) Appl. No.: 10/339,825

(22) Filed: Jan. 10, 2003

(51) Int. Cl. G06F 17/60

(52) U.S. Cl. 705/5

(57) ABSTRACT

Each table in a restaurant has a switch coupled to a wireless transmitter. When the switch is activated, the transmitter broadcasts a vacant table signal. The vacant table signal is received by a receiver that is coupled to a computer system. The computer responds to a vacant table signal by identifying a particular table as being vacant, and therefore ready for seating of a party. The computer is programmed to represent each table in the restaurant with an icon. The computer may be programmed to present a table as being in one of three states: (1) vacant; (2) occupied; and (3) anticipated to be vacant soon. When a party is seated at a particular table, this fact is entered into the computer, and the computer presents the table as occupied. The table is regarded as occupied until one of two events occurs. If the party leaves, the table will be bussed, and thereafter, the switch/transmitter circuit at the table will be activated. In response, the transmitter will transmit a vacant table signal, and the computer will present the table as vacant. Further, a table may be returned to a vacant state by manual command executed at the computer. Alternatively, if the occupancy duration of the table exceeds a threshold, the computer will draw the inference that it is likely that the party will soon leave. Accordingly, the computer will present the table as anticipated to be vacant soon.

### TECHNICAL FIELD

The present application relates generally to a computerized table management system for deployment in a restaurant setting, and more particularly to a computerized table management system utilizing table-mounted transmitters to indicate table availability.

### BACKGROUND

Restaurant profitability depends, in part, upon ensuring that each table in a restaurant is occupied. During periods in which a table is vacant, it is not possible for the table to be generating revenue for the restaurant, meaning that the table effectively provides no return on its investment during such periods. It is also important to identify vacant tables within a restaurant to prevent wait-listed parties from needlessly waiting for a table. The longer a party must wait to be seated, the greater the possibility that the party leaves the restaurant to search for another restaurant with a shorter wait list.

Ordinarily, a restaurant employs an individual to scout its seating area, to keep track of which tables are vacant and which tables are occupied. Vacant and occupied tables are then typically recorded via a grease pencil on a laminated floor plan of the restaurant. The laminated floor plan is updated each time a party is seated and each time a vacant table is identified. Unfortunately, this process is subject to human error (a vacant table may go unobserved for some period of time or an employee may forget to update the laminated floor plan when a party is seated). Further, the employee assigned the task of scouting the restaurant to identify vacant tables is often assigned other tasks that may prevent the employee from seeking vacant tables for several minutes (or more) at a time. As mentioned earlier, these shortcomings result in decreased restaurant profitability and increased customer dissatisfaction.

As is evident from the foregoing, there exists a need for a system by which vacant tables in a restaurant may be automatically identified. A desirable system will require minimal human effort to maintain. Further, a desirable system will minimize the possibility of interference with the system on the part of customers. Still further, a desirable system will be easily retrofitted into existing restaurant structures.

### SUMMARY OF THE INVENTION

Against this backdrop, the present invention was developed. A system for tracking table occupancy and vacancy in a restaurant setting may include a plurality of switch and transmitter combinations. Each such combination may include a switch coupled to a wireless transmitter, arranged so that a vacant table signal is transmitted in response to the switch being activated. Each switch and transmitter combination may be located at one of a plurality of tables in the restaurant. A host computer may be located in the restaurant. The host computer may have a receiver configured to receive the vacant table signals transmitted by the switch and transmitter combinations. The host computer may be programmed to graphically represent the plurality of tables in the restaurant. The host computer may also graphically indicate whether each table is available, occupied, or anticipated to be available soon. Further, the host computer may determine that a particular table is anticipated to be available soon based upon occupancy duration of the table as compared to a threshold.

According to another embodiment, a system for tracking table occupancy and vacancy in a restaurant setting may include a switch coupled to a wireless transmitter, arranged so that a vacant table signal is transmitted in response to the switch being activated by a remote activation device. The switch and transmitter combination may be located at a plurality of tables in the restaurant. A host computer may be located in the restaurant. The host computer may have a receiver configured to receive the vacant table signals transmitted by the switch and transmitter combinations. The host computer may be programmed to indicate whether each of the plurality of tables in the restaurant is available or occupied. The host computer may also be programmed to determine that a particular table is available based upon the reception of a vacant table signal.

According to yet another embodiment, a computer system that is coupled to a receiver may be programmed to present a graphical representation of a plurality of tables in a restaurant. It may also be programmed to receive a transmitted message frame, and associate the received message frame with a particular transmitter, where the particular transmitter is associated with one of the tables. Further, it may be programmed to alter the graphical representation of a particular table, in response to a party being seated at the particular table. Additionally it may be programmed to alter the graphical representation of the particular table, in response to receiving a transmission associated with the particular table. The graphical representation of the particular table may contain a numeral indicating seating capacity of the particular table. The numeral indicating seating capacity may be replaced by a timer value indicating table occupancy duration, in response to a party being seated at the particular table.

According to yet another embodiment, a method of constructing a graphical representation of a plurality of tables in a restaurant may be carried out in the following context. The graphical representation resides in a computer system coupled to a receiver that is in communication with a plurality of transmitters. Each transmitter is assigned to one of the plurality of tables. Each transmitter is responsive to a stimulus that causes the transmitter to transmit a unique message frame to the receiver. The computer system may be programmed to respond to a received message frame by checking to determine if the unique message frame had already been received during the current construction process. If the message frame had not been received, it may display an icon representing the table. The method includes subjecting each transmitter to the stimulus, thereby causing each transmitter to send the message frame to the receiver, and thereby causing the computer system to display one icon for each table.

According to yet another embodiment, a method for tracking table occupancy and vacancy in a restaurant setting includes identifying that a table at a restaurant is vacant, based upon a computerized graphical representation indicating that the table is vacant. Next, a party is seated at the vacant table. The occurrence of having seated the party at the table is recorded in a host computer system, thereby causing the host computer to regard the table as occupied. Finally, a switch located at the table is activated with a remote activation device, in response to having bussed the table, wherein activation of the switch causes the host computer to regard the table as vacant.

According to yet another embodiment, a method of constructing a graphical representation of a plurality of tables in a restaurant may include receiving a signal from a transmitter associated with one of the plurality of tables in the restaurant. Next, positional information regarding point of origination of the signal is determined. Finally, a table icon is generated and placed on a region of a computer monitor based upon the positional information.

### BRIEF DESCRIPTION OF THE DRAWINGS

FIG. 1 depicts an exemplary restaurant utilizing a table management system, in accordance with one embodiment of the present invention.

FIG. 2 depicts a state transition diagram that may be employed for each table in a restaurant, in accordance with one embodiment of the present invention.

FIG. 3 depicts another state transition diagram that may be employed for each table in a restaurant, in accordance with one embodiment of the present invention.

FIG. 4 depicts a flowchart identifying the operation of the table management system, in accordance with one embodiment of the present invention.

FIG. 5 depicts a user interface for the table management system, in accordance with one embodiment of the present invention.

FIG. 6 depicts a table icon, in accordance with one embodiment of the present invention.

FIG. 7 depicts a method of constructing the iconic representation presented in the main seating viewing area of FIG. 5, in accordance with one embodiment of the present invention.

FIG. 8 depicts a table with a switch/transmitter circuit attached thereto, in accordance with one embodiment of the present invention.

FIG. 9 depicts another view of a user interface for the table management system, in accordance with one embodiment of the present invention.

### DETAILED DESCRIPTION

A computerized table management system that solves the aforementioned problems (and other problems, as well) includes the following. Each table in a restaurant has a switch coupled to a wireless transmitter. When the switch is activated, the transmitter broadcasts a vacant table signal. The vacant table signal is received by a receiver that is coupled to a computer system. The computer system may be located by a host stand, for example. The computer typically responds to a vacant table signal by identifying a particular table as being vacant, and therefore ready for seating of a party.

The computer is programmed to represent each table in the restaurant with an icon. The computer may be programmed to present a table as being in one of three states: (1) vacant; (2) occupied; and (3) anticipated to be vacant soon. The state of a particular table may be indicated by some distinguishing characteristic, e.g., the color of the table's icon. Upon powering up, each table is regarded as vacant by default. When a party is seated at a particular table, this fact is entered into the computer, and the computer presents the table as occupied. The table is regarded as occupied until one of three events occurs. If the party leaves, the table will be bussed, and thereafter, the switch/transmitter circuit at the table will be activated. In response, the transmitter will transmit a vacant table signal, and the computer will present the table as vacant. Further, an occupied table may be manually returned to the vacant state at the computer. This permits the system to account for an occurrence wherein a switch/transmitter is not activated when the table becomes vacant (for example, a party changes tables, meaning that the table is not bussed and the switch/transmitter is not activated). Alternatively, if the occupancy duration of the table exceeds a threshold, the computer will draw the inference that it is likely that the party will soon leave. Accordingly, the computer will present the table as anticipated to be vacant soon.

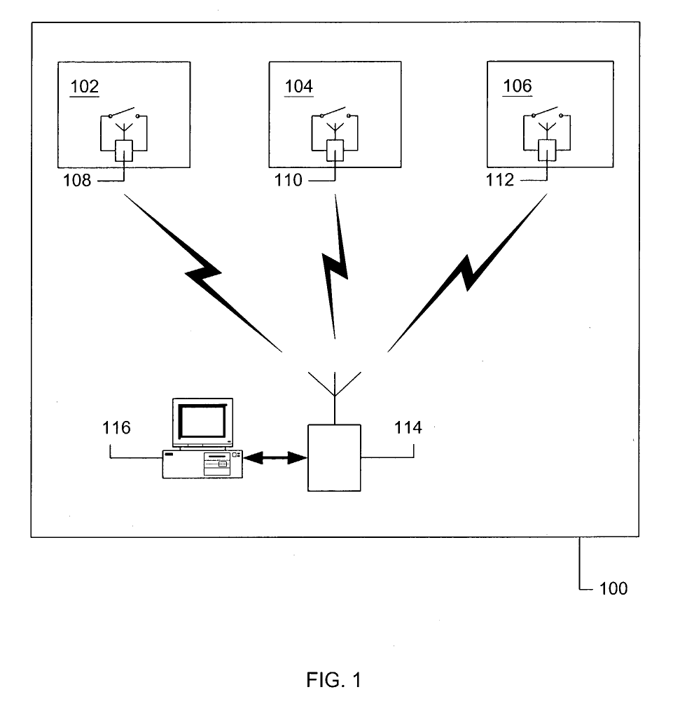

FIG. 1 depicts an exemplary restaurant 100 equipped with a table management system. As can be seen from FIG. 1, the restaurant 100 has three tables 102, 104 and 106. Each table 102, 104, and 106 has a transmitter/switch circuit 108, 110, and 112 associated therewith. The transmitters 108, 110, and 112 are in communication with a receiver 114 that is coupled to a host computer 116.

The switch/transmitter circuits 108, 110, and 112 transmit a vacant table signal upon activation of the switch. The switch may be a physical switch that is activated manually by depressing a button, for example. Preferably, the switch is remote activated, meaning that a remote activation device is required for activation of the switch. An example of such a switch is a reed switch or other magnetically activatable switch that changes states in the presence of a magnetic field (per such an embodiment, a magnet serves as the remote activation device). Other examples of a remotely activated switch include an infrared detector (per such an embodiment, an infrared transmitter serves as the remote activation device) and a magnetoresistive element (again using a magnet as the remote activation device).

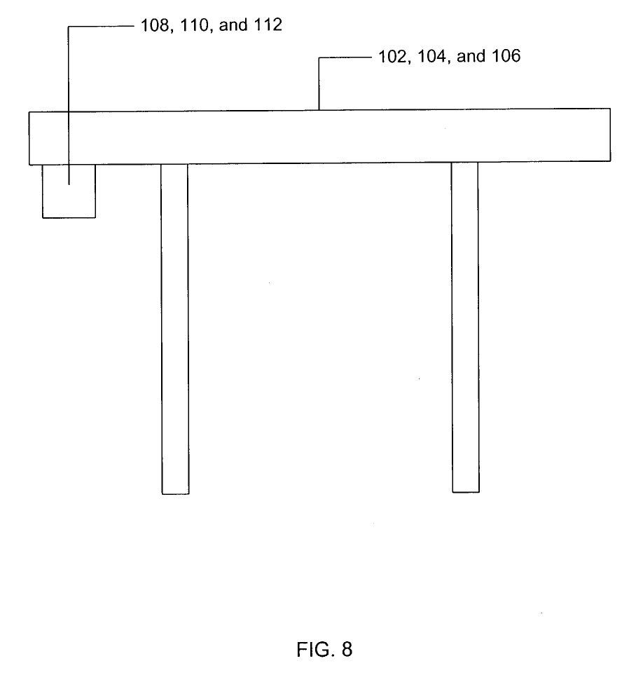

The switch/transmitter circuits 108, 110, and 112 should be located in physical proximity of the tables with which they are associated. Preferably, the transmitter/switch circuits 108, 110, and 112 are mounted on the under surface of the tables 102, 104, and 106, as shown in FIG. 8. In the case where then switch is a reed switch, the transmitter/switch circuits 108, 110, and 112 may be mounted (e.g., by adhesive systems or mechanical fastening systems, such as Command™ Adhesive products, 3M™ Dual Lock™ reclosable fasteners, 3M™ ScotchMate™ Hook-and-Loop Reclosable Fasteners, or 3M™ Self-Stick Interlocking Fasteners) to the under surface of the table, approximately ¼″ from the table's edge. Such a mounting scheme keeps the transmitter/switches 108, 110, and 112 generally out of sight, meaning that the transmitter/switches 108, 110, and 112 are less apt to be tampered with.

Upon activation of the transmitter/switch circuits 108, 110, and 112, a transmission frame (a vacant table signal) is broadcast from the transmitters 108, 110, and 112. Preferably, the transmission scheme is simplex, so that the cost of the table management system is reduced (by virtue of eliminating the need for a receiver at each of the tables 102, 104, and 106). A transmission frame includes transmitter identifier data. For example, a transmission frame may include two bytes of data that uniquely identify the transmitter from which the transmission frame emanated (a first transmitter's message frame may have a transmitter identifier of 0x000, while a second transmitter's message frame may have a transmitter identifier of 0x0002). Optionally, a message frame may include a bitmapped set of status data. For example, according to one embodiment, the switch and transmitter are contained in a housing. If the housing is opened, a bit within the status data may be asserted, indicating that the switch/transmitter has been tampered with. According to another embodiment, the switch/transmitter circuits are battery operated. Upon the battery voltage dropping beneath a particular threshold, a second bit within the status data may be asserted, indicating low battery voltage. According to yet another embodiment, the switch/transmitter circuits 108, 110, and 112 may periodically transmit a message frame for the purpose of communicating the status information. Such a periodic transmission indicates that the switch/transmitter 108, 110, and 112 remains functional, and provides periodic information regarding its status.

Regardless of the particular structure of the message frame, the transmission itself may utilize amplitude modulation, frequency modulation, or phase modulation. Preferably, the transmitter utilizes frequency modulation. Optionally, each transmission of a message frame may be redundantly broadcast upon varying carrier frequencies, so as to reduce the likelihood of an interference signal preventing the successful reception of the message frame. For example, upon activation of a switch/transmitter 108, 110, and 112, a first transmission of a message frame may be carried upon carrier frequency f₁. Subsequently, a second transmission of the message frame may be carried upon carrier frequency f₂, and a third transmission may be carried upon carrier frequency f₃ (and so on). A commercial example of a transmitter/switch that utilizes a remote activation switch, a message frame structure as described above, and the aforementioned frequency-hopping scheme can be obtained from Inovonics Corp. (model #FA210M).

The computer 116 is in communication with a receiver 114 that receives transmissions from the switch/transmitter circuits 108, 110, and 112. The receiver 114 may communicate with the computer via an RS232 port or any other input/output port. An example of such a receiver 114 is available from Inovonics Corp. (model #FA403).

The computer 116 may be programmed to graphically represent each table in the restaurant with an icon. By changing the appearance of the icon, the computer 116 indicates whether a particular table is vacant or occupied. Typically, upon bussing of a table 102, 104, and 106, the busser activates the switch/transmitter 108, 110, and 112 (preferably, with a magnet). In response, the activated switch/transmitter 108, 110, and 112 broadcasts a vacant table signal (message frame). By virtue of receiving the vacant table signal, the computer 116 is alerted of the vacancy of the particular table 102, 104, and 106 that had just been bussed. The computer 116 responds by indicating that the table is vacant.

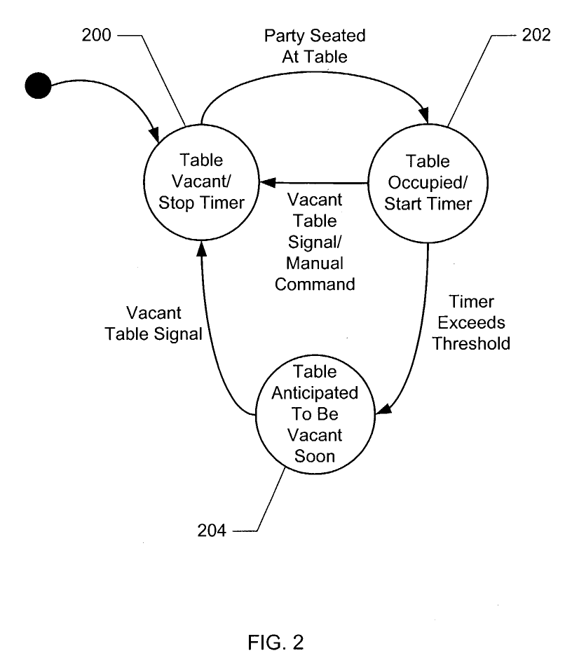

The computer 116 may be programmed to present each table 102, 104, and 106 as being in one of three states. Each table 102, 104, and 106 may progress through states, as shown in the state transition diagram of FIG. 2. Initially, a table is regarded as vacant, and is therefore in a table vacant state 200. Upon seating a party at a table, the table transitions from the table vacant state 200 to a table occupied state 202. As shown in FIG. 2, the computer may start a timer upon transitioning a particular table into the table occupied state 202. The purpose of the timer is to record the occupancy duration of the particular table.

Two state transitions are possible from the table occupied state 202. First, upon reception of a vacant table signal, the computer 116 causes the table associated with the vacant table signal to revert back to the vacant table state 200. As shown in FIG. 2, upon this state transition, the timer is stopped and the table occupancy duration is recorded. This same state transition also occurs as a result of a manual command, generated by an employee at the computer 116, to return a table to the vacant table state 200. Such a command allows the system to account for an occurrence wherein a switch/transmitter 108, 110, or 112 is not activated when the table becomes vacant (for example, a party changes tables, meaning that the table is not bussed and the switch/transmitter is not activated). Second, if the accumulated time in the timer exceeds a threshold while the table is in the table occupied state 202, the computer causes the table to transition to the table-soon-to-be-vacant state 204. A table transitions from the table-soon-to-be-vacant state 204 to the table vacant state 200 upon reception of a vacant table signal. Again, upon this state transition, the timer is stopped and the table occupancy duration is recorded.

The threshold that governs transition into the table-soon-to-be-vacant state 204 may be set by the user of the table management system. Alternatively, the computer 116 may be programmed to create a distribution regarding the occupancy times of the tables 102, 104, and 106 in the restaurant 100. The threshold may be calculated based upon the distribution. For example, the threshold may be equal to the mean or median table occupancy duration. Alternatively, the threshold may be calculated so as to be based upon knowledge of the distribution's mean and standard deviation. The distribution may also be used to calculate a projected waiting time for a party. Such a calculation may be based upon the number of parties waiting to be seated, the number of tables meeting the party's seating requirements (table occupancy, smoking preference, etc.), and the knowledge of the mean and/or standard deviation of the distribution.

The computer 116 may be programmed to present each table 102, 104, and 106 icon in a particular color, depending upon the state of the table 102, 104, and 106. For example, a vacant table 102, 104, and 106 may be represented by a green table icon, an occupied table 102, 104, and 106 by a red table icon, and a table 102, 104, and 106 that is anticipated to be vacant soon by a yellow table icon.

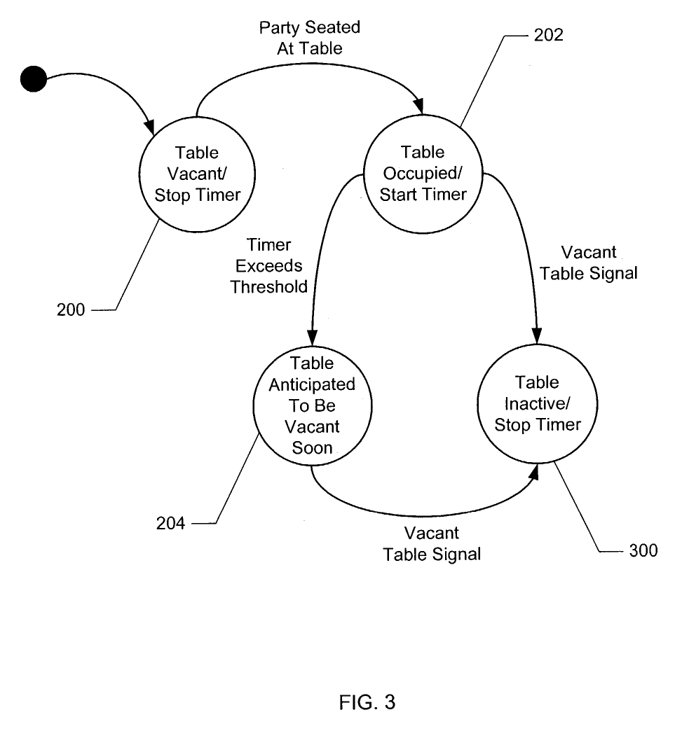

FIG. 3 depicts an alternate state transition diagram that the computer 116 may apply to a given table 102, 104, and 106. The state transition diagram of FIG. 3 depicts a set of states that allows a region of the restaurant to be “drained.” The state transition diagram of FIG. 3 is identical to the state transition diagram of FIG. 2, with the exception of an additional state: the table inactive state 300. The state transitions depicted in FIG. 3 are the same as those depicted in FIG. 2, with two exceptions. In FIG. 2, reception of a vacant table signal always caused a table to revert to the vacant table state 200. In FIG. 3, reception of a vacant table signal causes a table to transition to the table inactive state 300. Accordingly, FIG. 3 differs from FIG. 2 in that a vacant table signal causes a transition from the table occupied state 202 to the inactive state 300, and also causes a transition from the table-soon-to-be-vacant state 204 to the inactive state. An inactive table maybe presented as being grayed out. A grayed out table icon indicates that the table is not available for seating of a party. Thus, a table in drain mode will not be used again once the party at the table leaves. By putting every table in a section of a restaurant into drain mode, a section (such as an outdoor patio) can be drained of people, so that the section can be closed at a particular time, for example.

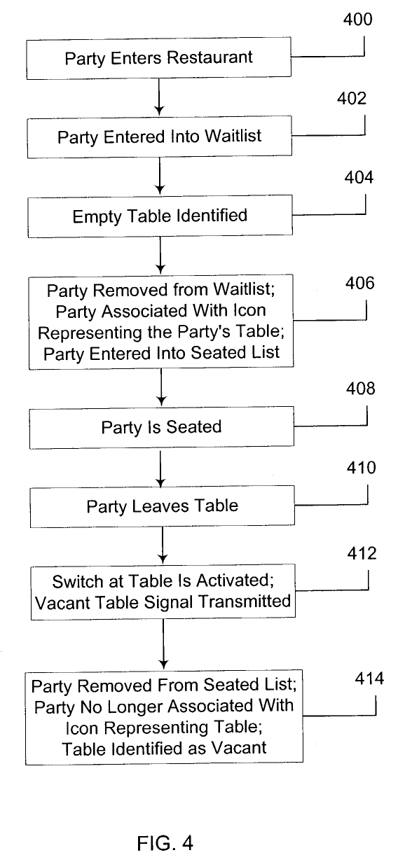

FIG. 4 depicts a flowchart identifying the operation of the table management system. Use of the table management system is initiated by a party entering the restaurant 100, as shown in operation 400. In response to a party entering the restaurant, the party's name (along with smoking preference and party size) is entered into a waitlist maintained on the computer 116, as shown in operation 402. An example waiting list is described further later herein. The waiting list can also reflect the amount of time a party has been waiting and the section the party prefers. Next, in operation 404, a vacant table (with sufficient seating capacity and with appropriate smoking designation) is identified based upon the iconic display presented by the computer 116.

Prior to a party being seated at the identified vacant table, several actions occur, as shown in operation 406. First, the party is removed from the waitlist. Additionally, the party's name is associated with the table icon representing the table 102, 104, and 106 at which the party will be seated. For example, the name of the party seated at the table 102, 104, and 106 may appear on the table icon, while the party is seated at the table 102, 104, and 106. Finally, the party's name is entered into a list of seated parties. Thereafter, the party is seated at the table, as shown in operation 408.

The next set of activities occurs when the party leaves, as shown in operation 410. In response to the party leaving, the table 102, 104, and 106 is bussed. After completion of bussing, the busser activates the switch/transmitter 108, 110, and 112 (preferably with a remote activation device, such as with a magnet). This causes the transmitter 108, 110, and 112 to transmit a vacant table signal, as shown in operation 412.

Reception of the vacant table signal causes several events to occur, as shown in operation 414. Initially, in response to receiving a vacant table signal, the party's name associated with the particular received vacant table signal is removed from the list of seated parties. Next, the association between the party's name and the table icon associated with the vacant table signal is severed (for example, the party's name is removed from the table icon). Finally, the computer 116 presents the table as being vacant (for example, the computer 116 may change the table icon to be green).

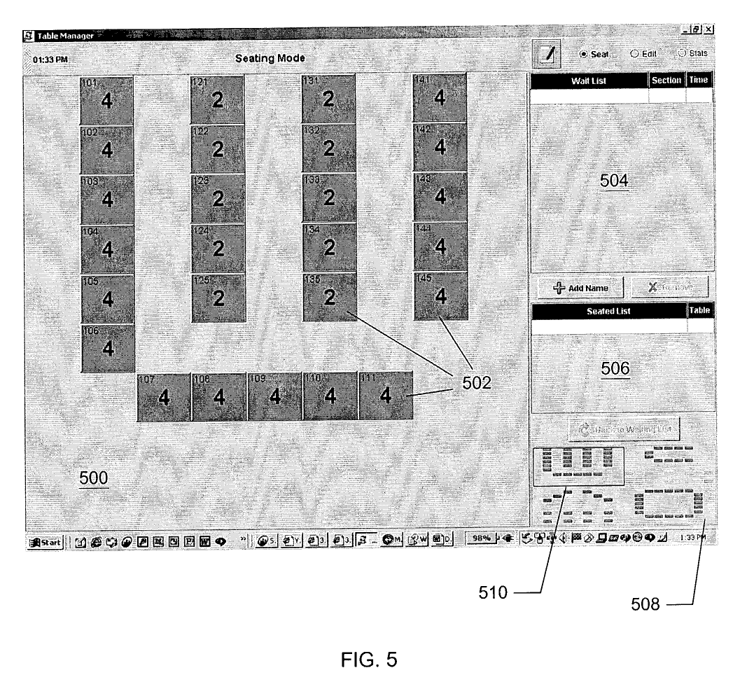

FIG. 5 depicts a user interface for use with the table management system. The user interface includes a main seating viewing area 500, which contains a plurality of table icons 502. Each table icon represents a table 102, 104, and 106 in the restaurant 100. The table icons 502 may be dragged and dropped in an arrangement that resembles a floor plan of the restaurant. Alternatively, the table icons 502 may be arranged in a default pattern, in which, while each table icon 502 represents a table 102, 104, and 106 in the restaurant 100, the placement of the table icon 502 in the main seating viewing area 500 does not indicate the table's physical location in the restaurant 100.

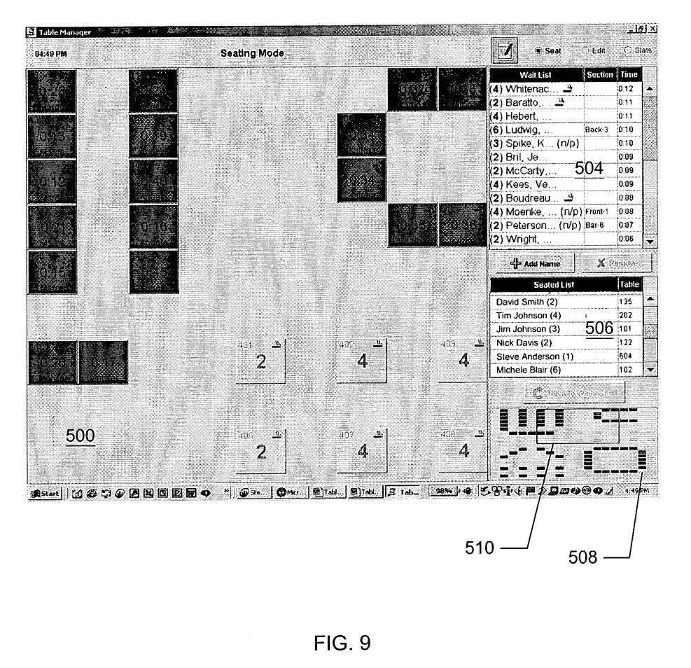

The user interface is able to accommodate a restaurant that requires more table icons than can fit in the main seating viewing area 500. An alternate seating viewing area 508 depicts every table icon associated with the restaurant. A “viewport” 510 is contained within the alternate seating viewing area 508. The viewport 510 selects a region of the alternate seating viewing area 508 for display in the main seating viewing area 500. The viewport 510 may be dragged and dropped within the alternate seating viewing area 508, meaning that the user can select which portion of the restaurant the user wishes to view in the main seating viewing area 500. FIG. 9 depicts the user interface of FIG. 5, but with different data displayed. FIG. 9 shows the viewport 5 10 in a different position, so that a different group of tables is displayed in the main seating viewing area 500.

The user interface also includes a waitlist viewing area 504 and a seated list viewing area 506, as shown in FIGS. 5 and 9. Names of parties waiting for tables are presented in the waitlist viewing area 504. The data presented in this area corresponds to the data discussed with reference to operations 402 and 406 of FIG. 4. Names of parties that are seated at a table 102, 104, and 106 are presented in the seated list viewing area 506. The data presented in this area corresponds to the data discussed with reference to operations 406 and 414 of FIG. 4.

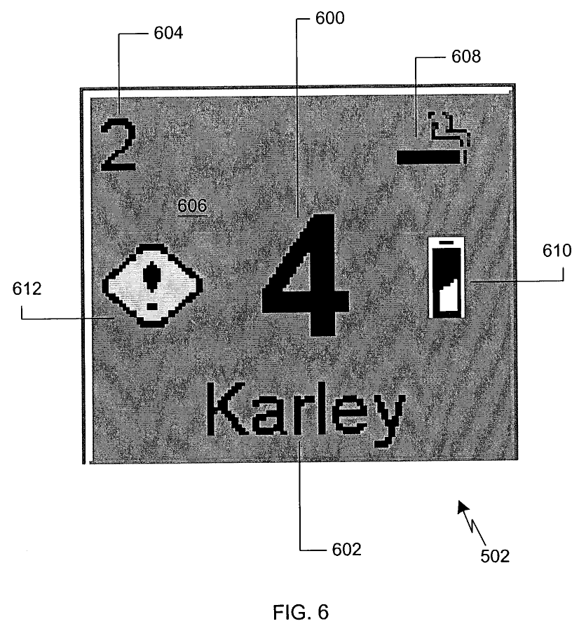

FIG. 6 depicts an enlarged view of a table icon 502. As can be seen from FIG. 6, the table icon 502 is rectangular in shape and contains a numeral (i.e., 4 in the example depicted in FIG. 6) representing seating capacity 600 in the middle of it. While a party is seated at the table, the numeral representing seating capacity 600 may be replaced with a timer value presenting the occupancy duration of the table represented by the table icon 502. Centered along the bottom of the table icon 502, the name of the server 602 (i.e., Karley in the example depicted in FIG. 6) assigned to the table is presented. The server name 602 may be entered when the party is being seated. Alternatively, the server name 602 may be assigned to a group of tables, so that the server name 602 need not be entered each time a party is seated at a table within the group. In the upper left-hand corner of the table icon 502, the table number 604 is presented. Alternatively, the server name 602 may be replaced with the party name.

The body 606 of the table icon 502 may change a distinguishing symbol, e.g., color, depending upon the state of the table the icon 502 is representing. For example, the body 606 may be green when the table is vacant, red when it is occupied, yellow when it is soon to be vacant, and gray when the table is inactive.

The table icon 502 contains various indicators. A smoking indicator 608 appears in the upper right-hand corner of the table icon. The smoking indicator 608 lets the user know whether the particular table is designated as smoking or non-smoking. A low battery indicator 610 is placed beneath the smoking indicator 608. The low battery voltage indicator 610 is presented in response to a low battery voltage bit being asserted in the status data of a message frame associated with the table. Finally, a tamper indicator 612 appears centered along the left-hand side of the table icon 502. The tamper indicator 612 is presented in response to a tamper indicator bit being asserted in the status data of a message frame associated with the table.

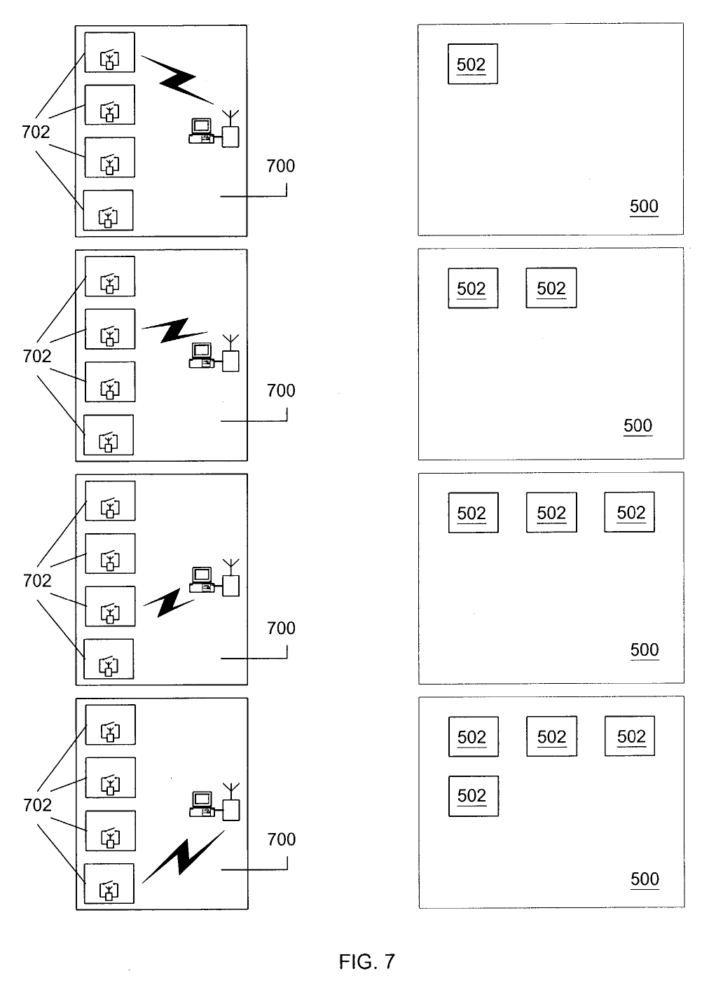

FIG. 7 depicts a method of constructing the iconic representation presented in the main seating viewing area 500 of FIG. 5. The table management system may be put into a construct-table-icons mode. In response to entering this mode, the computer 116 awaits transmission of message frames from the switch/transmitter circuits.

FIG. 7 depicts a main seating viewing area 500 as it is populated with table icons 502 representing tables 702 in an exemplary restaurant 700. The process of populating the main seating viewing area 500 with table icons 502 is performed during set-up of the restaurant table management system. The set-up scheme depicted in FIG. 7 is significant in that it is simple to perform and can be completed easily by restaurant personnel. This stands in stark contrast to other set-up schemes that require the assistance of technical personnel for completion.

Initially, the main seating viewing area 500 is empty (this is not depicted). Thereafter, a first switch/transmitter circuit associated with a first table is activated. Thus, the transmitter broadcasts a vacant table signal. In response, the computer 116 creates a table icon associated with the transmitter identification data embedded in the vacant table signal. The table icon is placed in the upper left-hand corner of the main seating viewing area 500. The table icon is given a table number of n (n may be set to any value by the user).

Thereafter, a second switch/transmitter circuit associated with a second table is activated. The transmitter broadcasts a vacant table signal. In response, the computer 116 checks to see whether a table icon is already associated with the transmitter identification data embedded in the newly received vacant table signal. If a table icon is already associated with the transmitter identification data embedded in the newly received vacant table signal, this means that the transmitter/switch has already been activated, and an icon has already been created for the table associated with the particular transmitter/switch. If no table icon is associated with the transmitter identification data embedded in the newly received vacant table signal, a new table icon is created, and is placed by the first table icon. The newly created table icon may be given a table number of n+1. Alternatively, the newly created table icon may be assigned a table number of the user's choosing.

The user simply proceeds to activate the transmitter/switch associated with every table in the restaurant. In response, a table icon is created for every table in the restaurant. A table icon is associated with the transmitter identification data that is embedded in the vacant table signal responsible for initiating the creation of the particular table icon. Upon creation of a table icon, it is placed in the main seating viewing area 500, next to the last created table icon. If a row becomes full, the table icon is placed in the next row.

Upon having activated every transmitter/switch circuit in the restaurant, a table icon representing every table in the restaurant will have been created. As mentioned earlier, the table icons may be dragged and dropped in a pattern that is congruous with that of the physical layout of the restaurant. Alternatively, the table icons may be left in their default layout. At the end of the process, the layout may be saved.

Optionally, the restaurant may be outfitted with a plurality of antennae, which are in communication with a triangulation device. The triangulation device is, in turn, in communication with the computer. When a particular transmitter/switch circuit is activated, the computer receives information regarding the position of the transmitter/switch circuit. Based upon the received information, the computer 116 orients the newly-generated table icon on the main seating viewing area 500, so as to have its position therein reflect its physical position in the restaurant. This scheme eliminates the need for restaurant personnel to manually drag and drop the table icons into an arrangement mimicking that of the physical layout of the restaurant. Furthermore, in settings in which tables are set up and taken down on a daily basis (an outdoor patio, for example), this scheme eliminates the need to ensure that the same table is placed in the same location from day to day. Rather, each day after setting up the tables, the transmitter/switch circuit at each table could be quickly activated, and the main seating viewing area 500 would be populated with table icons arranged representing their physical layout.

The various embodiments described above are provided by way of illustration only and should not be construed to limit the invention. Those skilled in the art will readily recognize various modifications and changes which may be made to the present invention without strictly following the exemplary embodiments and applications illustrated and described herein and without departing from the true spirit and scope of the present invention which is set forth in the following claims.

The claimed invention is:

1. A system for tracking table occupancy and vacancy in a restaurant setting, the system comprising:
a plurality of switch and transmitter combinations comprising a switch coupled to a wireless transmitter, arranged so that a vacant table signal is transmitted in response to the switch being activated, each switch and transmitter combination being located at one of a plurality of tables in the restaurant;
a host computer located in the restaurant, the host computer having a receiver configured to receive the vacant table signals transmitted by the switch and transmitter combinations;
wherein the host computer is programmed to
graphically represent the plurality of tables in the restaurant;
graphically indicate whether each table is available, occupied, or anticipated to be available soon; and
determine that a particular table is anticipated to be available soon based upon occupancy duration of the table as compared to a threshold.

2. The system of claim 1, wherein the computer is programmed to calculate the threshold based upon measured average table occupancy duration.

3. The system of claim 2, wherein the computer is programmed to:
start a timer for a given table whenever a party is seated at the given table;
stop the timer upon reception of a vacant table signal associated with the given table, thereby determining an occupancy duration of the given table;
calculate an average occupancy duration based upon a plurality of measured occupancy durations; and
set the threshold equal to the average occupancy duration.

4. The system of claim 1, wherein the computer is programmed to:
start a timer for a given table whenever a party is seated at the given table;
stop the timer upon reception of a vacant table signal associated with the given table, thereby determining the occupancy duration of the given table;
calculate a standard deviation of a plurality of measured occupancy durations; and
determine the threshold based upon the calculated standard deviation.

5. The system of claim 1, wherein the computer is programmed to calculate the threshold based upon a median of the occupancy durations.

6. The system of claim 1, wherein the computer is programmed to change the graphical representation of a table when the occupancy duration of the table exceeds the threshold.

7. The system of claim 1, wherein the computer is programmed to calculate an anticipated wait time for a party on a wait list, based in part upon the anticipation that a particular table is soon to be available.

8. A system for tracking table occupancy and vacancy in a restaurant setting, the system comprising:
a switch coupled to a wireless transmitter, arranged so that a vacant table signal is transmitted in response to the switch being activated by a remote activation device, the switch and transmitter combination being located at a plurality of tables in the restaurant;
a host computer located in the restaurant, the host computer having a receiver configured to receive the vacant table signals transmitted by the switch and transmitter combinations;
wherein the host computer is programmed to
indicate whether each of the plurality of tables in the restaurant is available or occupied; and
determine that a particular table is available based upon the reception of a vacant table signal.

9. The system of claim 8, wherein the switch and transmitter combination is battery powered.

10. The system of claim 9, wherein the switch and transmitter combination is configured and arranged to transmit a low battery indication signal, in response to battery voltage dropping beneath a battery voltage threshold.

11. The system of claim 8, wherein the switch and transmitter combination is connected to a bottom surface of a table.

12. The system of claim 8, wherein the switch and transmitter combination is contained in a single housing.

13. The system of claim 12, wherein the switch and transmitter combination is configured and arranged to transmit a tamper indication signal, in response to the housing being opened.

14. The system of claim 8, wherein the switch comprises a magnetically activated switch, and the remote activation device comprises a magnet.

15. A computer system coupled to a receiver, the computer system being programmed to:
present a graphical representation of a plurality of tables in a restaurant;
receive a transmitted message frame, and associate the received message frame with a particular transmitter, where the particular transmitter is associated with one of the tables;
alter the graphical representation of a particular table, in response to a party being seated at the particular table;
alter the graphical representation of the particular table, in response to receiving a transmission associated with the particular table;
wherein the graphical representation of the particular table contains a numeral indicating seating capacity of the particular table; and
wherein the numeral indicating seating capacity is replaced by a timer value indicating table occupancy duration, in response to a party being seated at the particular table.

16. The computer system of claim 15, wherein the computer is programmed to graphically represent each of the plurality of tables as a rectangle.

17. The computer system of claim 15, wherein the computer is programmed to include a name of a server assigned to a table within the graphical representation of the table.

18. The computer system of claim 15, wherein the computer is programmed to include a table number within the graphical representation of a table.

19. The computer system of claim 15, wherein the computer is programmed to include a low battery indicator within the graphical representation of a table, the low battery indicator signifying that a battery powering a transmitter assigned to the table is exhibiting a voltage beneath a battery voltage threshold.

20. The computer system of claim 15, wherein the computer is programmed to include a tamper indicator within the graphical representation of a table, the tamper indicator signifying that a housing enclosing a transmitter assigned to the table has been opened.

21. The computer system of claim 15, wherein the computer is programmed to present the graphical representation of a table in a first color while the table is vacant, and in a second color while the table is occupied.

22. The computer system of claim 21, wherein the first color is green.

23. The computer system of claim 21, wherein the second color is red.

24. The computer system of claim 21, wherein the computer is further programmed to present the graphical representation of the table in a third color, when measured occupancy time of the table exceeds a threshold.

25. The computer system of claim 24, wherein the third color is yellow.

26. A method of constructing a graphical representation of a plurality of tables in a restaurant, the graphical representation residing in a computer system coupled to a receiver that is in communication with a plurality of transmitters, each transmitter being assigned to one of the plurality of tables, each transmitter being responsive to a stimulus that causes the transmitter to transmit a unique message frame to the receiver, the computer system being programmed to respond to a received message frame by checking to determine if the unique message frame had already been received during the current construction process, and if the message frame had not been received, displaying an icon representing the table, the method comprising:
subjecting each transmitter to the stimulus, thereby causing each transmitter to send the message frame to the receiver, and thereby causing the computer system to display one icon for each table.

27. The method of claim 26, wherein the computer system is programmed to permit each displayed icon to be selected and dragged to a desired location, the method further comprising:
selecting and dragging each displayed icon, so that the displayed icons are arranged in a pattern approximating that of the restaurant.

28. The method of claim 26, wherein each transmitter is subjected to the stimulus on a one-by-one basis.

29. The method of claim 26, wherein the computer system is further programmed to select a location for display of an icon based, in part, upon the number of other icons already displayed.

30. A method for tracking table occupancy and vacancy in a restaurant setting, the method comprising:
identifying that a table at a restaurant is vacant, based upon a computerized graphical representation indicating that the table is vacant;
seating a party at the vacant table;
recording in a host computer system the occurrence of having seated the party at the table, thereby causing the host computer to regard the table as occupied; and
activating, with a remote activation device, a switch located at the table in response to having bussed the table, wherein activation of the switch causes the host computer to regard the table as vacant.

31. The method of claim 30, wherein the switch is a magnetically activated switch and is located on the under surface of the table, and wherein the activation step comprises passing a magnet in proximity to the switch.

32. A method of constructing a graphical representation of a plurality of tables in a restaurant, the method comprising:
receiving a signal from a transmitter associated with one of the plurality of tables in the restaurant;
determining positional information regarding point of origination of the signal; and
generating a table icon and placing the table icon on a region of a computer monitor based upon the positional information.

33. The method of claim 32, wherein the step of determining the positional information comprises triangulating the point of origin of the signal with a plurality of antennae.
